(19) United States
(12) Patent Application Publication
(10) Pub. No.: US 2013/0284960 A1
(43) Pub. Date: Oct. 31, 2013

(54) SOLENOID VALVE

(71) Applicants: Franz-Josef Schnelker, Neuss (DE); Werner Buse, Kaarst (DE); Christoph Sadowski, Bochum (DE); Rolf Lappan, Koeln (DE); Rolf Dohrmann, Kaarst (DE)

(72) Inventors: Franz-Josef Schnelker, Neuss (DE); Werner Buse, Kaarst (DE); Christoph Sadowski, Bochum (DE); Rolf Lappan, Koeln (DE); Rolf Dohrmann, Kaarst (DE)

(73) Assignee: PIERBURG GMBH, NEUSS (DE)

(21) Appl. No.: 13/994,134

(22) PCT Filed: Nov. 15, 2011
(86) PCT No.: PCT/EP2011/070123

§ 371 Date: Jun. 14, 2013

(30) Foreign Application Priority Data
Dec. 17, 2010 (DE) 102010055033.7

(51) Int. Cl. F16K 31/06

(52) U.S. Cl. CPC F16K 31/0658
USPC 251/129.15

(57) ABSTRACT

A solenoid valve includes a valve sleeve comprising a valve seat, a valve closure element which acts on the valve seat, and a housing. Arranged in the housing is a coil, an armature, a core, and a multiple-part return-path arrangement, which form an electromagnetic circuit. The core is arranged on a side of the housing opposite to the valve sleeve and is wound onto a coil former. The coil former comprises a first portion with an internal diameter and a receiving bushing for the valve sleeve arranged on a side opposite to the core. A movable armature acts on the valve closure element. The armature is mounted in the coil former via a bearing and comprises parts including a first part directed toward the core having a diameter. The diameter of the first part is larger than the internal diameter of the first portion of the coil former.

The invention refers to a solenoid valve having a housing, in which a coil which is wound onto a coil former, an armature, a core and a multiple-part return-path arrangement are arranged, which form an electromagnetic circuit, wherein the movable armature is mounted in the coil former via bearing means and acts directly or indirectly on at least one valve closure element, wherein the valve closure element acts on at least one valve seat which is arranged in a valve sleeve.

Various fields of application in internal combustion machines are known for solenoid valves. Solenoid valves are used both in pneumatic and in hydraulic circuits in vehicles, such as in brake equipment, brake systems or injection systems. Moreover, they can be used to control the pressure of pneumatic actuators or as divert-air valves in turbochargers, for example. Depending on the field of application, these solenoid valves are configured either as open/close valves or as proportional control valves.

For a simple adaptation of the general arrangement of a solenoid valve to the various fields of application, WO 2007/065566 A1 discloses a modular valve structure system comprising an electromagnetically actuated valve, for which a particular orientation and design of the core in the coil former is described essentially. The arrangement of the core presented in this publication, however, seems very costly under aspects of automated manufacture and is not suitable for separation into an automated preassembly of the electromagnetic circuit and the final assembly with the components specific to a respective application.

Therefore, it is an object of the invention to provide a solenoid valve that avoids the above-mentioned disadvantages.

This object is achieved with a solenoid valve by providing the core on the side of the housing opposite the valve sleeve and by building the armature from a plurality of parts, wherein a first part directed towards the core has a diameter larger than the inner diameter of a portion of the coil former, and wherein the coil former comprises a receiving bush for the valve sleeve, the receiving bush being provided on the side opposite the core, wherein the coil former and the receiving bush are configured in one piece. In this manner, a solenoid valve is provided whose electromagnetic circuit can be manufactured substantially in a preassembly process and which can afterwards be provided with the application-specific components during the final assembly process. Here, it is particularly advantageous under aspects of assembly, if at least parts of the return-path arrangement are arranged in the coil former. It is also advantageous, if a portion of the core opposite the armature has a larger diameter than a portion of the coil former opposite the valve closure element.

For an economic final assembly, it is particularly advantageous if the valve plunger is adapted to be connected with the armature by means of a plug connection. Here, the plug connection may also be adjustable.

The receiving bush and the valve sleeve should advantageously be connected through a welding joint.

In order to ensure, in a simple and economic manner, a coaxial extension of the armature in the solenoid valve, the portion of the coil former may comprise a bearing bush for the armature. It is further possible to design the portion of the coil former as a bearing portion for the armature. In a particularly advantageous manner, the coil former is made in an injection molding process. In this context, the coil former may be made from a dimensionally and temperature stable material, such as Grivory HT2V 3HLV or Grivory XE388, for example.

Embodiments of the invention are illustrated in the drawing and will be described hereunder.

In the Figures:

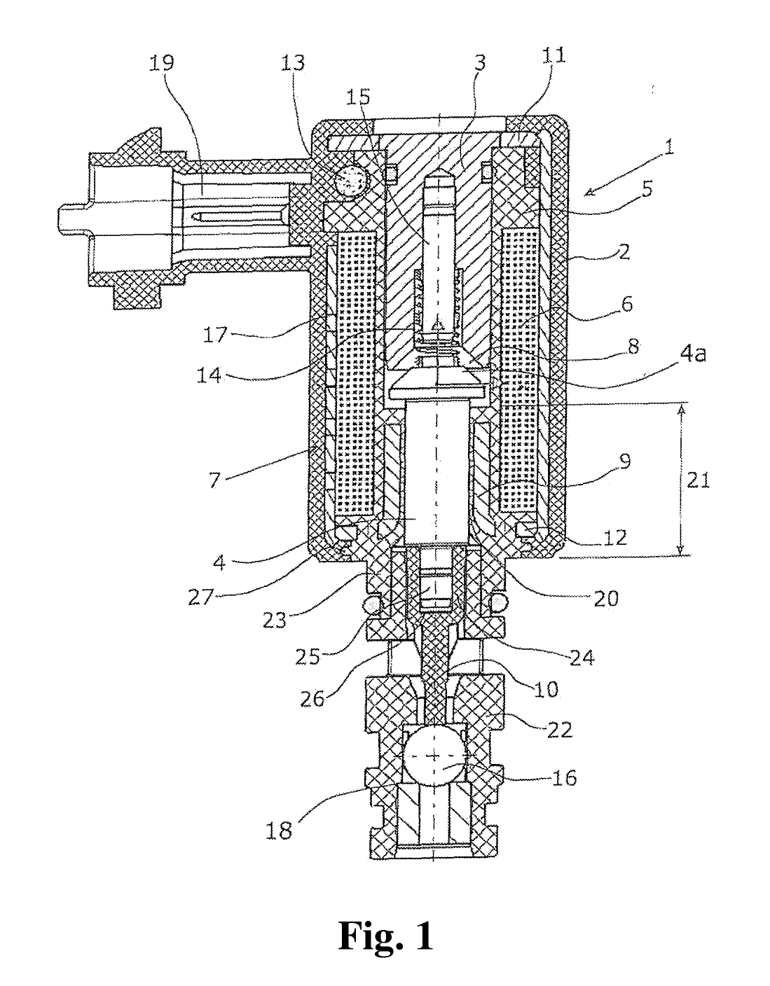

FIG. 1 is a sectional view of a solenoid valve of the present invention, and

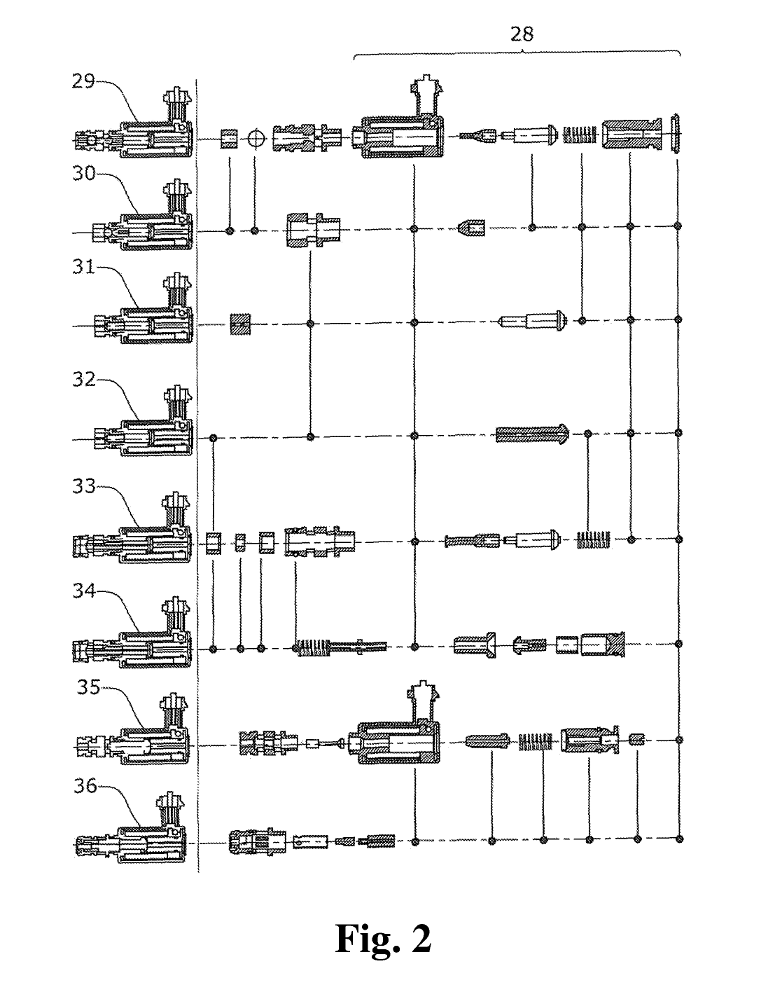

FIG. 2 is a subassembly drawing for solenoid valve designs to be manufactured in different ways.

FIG. 1 illustrates a solenoid valve 1 of the present invention in sectional view, the valve being used as an oil pressure control valve. This solenoid valve 1 comprises a housing 2 in which a core 3, an armature 4, a coil former 5 with a coil 6 wound thereon, and a return-path arrangement 7 are arranged. In the present case, the armature 4 is connected with a valve plunger 10 through a plug connection, which valve plunger acts on a valve closure element 16 in a manner known per se. The valve plunger 10 moves in a valve sleeve 22 inserted in a receiving bush 23 formed on a side of the coil former 5 opposite the core 3, wherein the receiving bush 23 is integrally connected with the coil former 5.

Such a solenoid valve, whose functionality is known per se, operates as follows: In the de-energized state, a gap 8 exists between the armature 4 and the core 3, in which a magnetic field is generated when the coil 6 is energized, whereby an axial movement of the armature 4 is caused. Correspondingly, the valve plunger 10 connected with the armature 4 is also moved and the valve closure element 16 is released.

In the present embodiment, a return-path inner section 9 is formed integrally with the return-path cover section 12 averted from the core 3, and is arranged in a manner integrated in the coil housing 5. Here, the return-path inner and cover sections 9, 12 have been included when the coil former 5 was manufactured in an injection molding process. Further, an interference suppression resistance 13 is already provided in the coil former 5. In this manner, essential components can be provided in the coil former 5 during pre-assembly. During the manufacture of a standard coil component, it is thus only necessary to select the coil 6 chosen for the valve function and to mount it on the coil former 5. After the second return-path cover section 11 has been placed and the return-path side section 17 has been engaged in a pressed connection with the return-path cover sections 11, 12 such that an electromagnetic circuit can be formed, and the contacting with an electric plug 19 has been made, the solenoid valve 1 is finished by being overmolded with the outer housing 2. In doing so, a contour is provided between the outer housing 2 and the coil former 5, which provides a kind of labyrinth-like seal 27 in order to increase the effect of sealing from the atmosphere.

In the present case, the solenoid valve is then finished by arranging the core 3, the armature 4 and the associated components, such as a spring 14 that, in the present case, maintains the armature 4 under a bias, as well as a stop pin 15 adjustably provided in the core 3. Here, it is useful for positioning, if a portion of the core 3 opposite the armature 4 has a larger diameter than a portion of the coil former 5 opposite the valve closure element 16.

In the present embodiment, bearing means 20 for the armature 4 are formed by the coil former 5, the bearing region 21 substantially coinciding with the region in which the return-path inner section 9 is provided. This embodiment becomes possible due to the fact that a first part 4a of the armature part 4, facing towards the core, has a diameter that is larger than the inner diameter of a portion 21 of the coil former 5. Besides the great advantage with respect to assembly, this is advantageous in that the bearing region 21 of the coil former 5 is positively reinforced by the inclusion of the return-path inner section 9. By applying a sliding layer in the bearing region 21, it is ensured that the armature 4 slides in the coil former with as little resistance as possible. The coaxial guiding of the armature 4 in the solenoid valve is ensured by the double function of the coil former 5 which, on the one hand, receives the core 3 and, on the other hand, acts as bearing means for the armature 4. Of course, it is also possible to provide a bearing bushing, which is not illustrated in detail herein, in the region 21.

For final assembly, the valve plunger 10 chosen for the valve function only has to be plugged on the armature 4, so that a plug connection 24 is established. For this purpose, the armature 4 comprises a pin 25 which is adapted to be inserted into a recess 36 in the valve plunger 10 and which is thereby connected with the same by force-fit or form-fit. Here, the pin 25 may further comprise a knurling, not illustrated in detail, by which the height of stroke can be adjusted. In the present embodiment, the valve plunger 10 is mounted during final assembly, together with the valve sleeve 22. Of course, it is also conceivable to provide a valve sleeve that is integrally connected with the coil former 5.

Due to the fact that in this case a part of the coil former 5 is formed as a receiving bush 23 for the valve sleeve 22, coaxiality errors can be avoided. It has proven advantageous that the coil former 5 is formed from a dimensionally and temperature stable material such as Grivory HT2V 3HLV, Grivory XE388, PPA or PA 4.6, for example.

FIG. 2 is a schematic subassembly drawing for different solenoid valves that form a modular system, such as pressure control valves, slide valves and seat valves.

Here, the modular system is formed by a standard coil component, which will be described later and which is intended to constitute the multiple-use component for use in valves with different hydraulic designs. Thus, the number of standard coil components is increased, the portion of the tool costs per piece is decreased and the coil becomes more economic on the whole. The standard coil component is the central element of this modular valve system. The different hydraulic objects can be achieved, on the one hand, with different built-in parts in the standard coil component (armature, core, spring) and, on the other hand, with special attachments to the standard coil.

In detail, the standard coil is intended for use in the following hydraulic valves:
3/2 way valve (29), type “ball valve” without pressure regulation,
2/2 way valve (30), type “ball valve” without pressure regulation,
2/2 way valve (31), type “slide valve” with pressure regulation,
2/2 way shut-off valve without pressure regulation (32)
3/2 way valve (33), mode “de-energized closed” with pressure regulation,
3/2 way valve (34), mode “de-energized open” with pressure regulation,
oil pressure modulator or proportional pressure valve (35) of the type “seat valve”,
oil pressure modulator or proportional pressure valve (35) of the type “slide valve”,

with further variants being conceivable, of course, in the future.

For all valves listed, the flow media of choice are oil, fuels and the like. The structure of the so-called standard coil component substantially comprises the parts mentioned in the context of FIG. 1, namely the coil former 5, the coil 6, the return-path arrangement 7 and the outer housing, including the electric plug 19. The standard coil component is open at both sides in the axial direction and allows both the mounting of electromagnetic functional parts into the component from the plug side and the attachment of hydraulic functional parts at the opposite side of the standard coil component.

In general, electromagnetic functional parts are the armature, the core and the spring. Together with the standard coil component, these form an electromagnetic drive 28. Different hydraulic applications require different electromagnetic drives or drive characteristics that differ in height and development of the magnetic force (over a valve stroke). For different magnetic force characteristics, the parts armature, core and spring have to be adjusted to each other, while the standard coil component remains the same. The standard coil component allows for the assembly of these different parts from the “plug side”.

The overmolded magnetic return-path inner and cover sections form a step-like shoulder within the coil that at the same time facilitates the assembly. All armatures provided are formed by a cylindrical part which moves, corresponding to the valve stroke, in the longitudinal direction within return-path guide, and a magnetically active part with a larger diameter. This enlarged diameter, together with the step within the standard coil component, prevents the armature from dropping out during the assembly of the solenoid valve or of the electromagnetic drive.

For example, the following pre-assembly succession is possible:

1) mounting the armature into the standard coil component with the armature head resting on the step inside the coil

2) mounting the spring

3) mounting the core incl. the abutment

Thereafter, the assembly of the basic structure of the electromagnetic drive would be complete. Simple on/off valves or 2/2 way and 3/2 way valves could already be assembled fitting accurately, while, for control valves (modulators, proportional valves), this would only be a first assembly step before the final adjustment process of the completed valve.

At the end opposite the plug, the standard coil component comprises a receiving bush, which actually is a part of the coil body. Using this receiving bush, different hydraulic functional parts can be fastened in the form of a valve sleeve—The outer housing of this valve sleeve may be manufactured from different materials such as steel, aluminum and plastic materials such as PA, PPA, PPS etc.

After the selection and composition of a suitable valve sleeve, the valve sleeve and the standard coil component are joined during the final assembly. The techniques suitable for joining the valve sleeve and the standard coil component basically are the following three techniques:
pressing the valve sleeve into the receiving bush of the standard coil component,
joining by vibration or ultrasound welding of the valve sleeve and the receiving bush of the standard coil component,
joining by laser welding of the valve sleeve and the receiving bush of the standard coil component.

1-10. (canceled)

11. A solenoid valve comprising:
a valve sleeve comprising at least one valve seat;
at least one valve closure element configured to act on the at least one valve seat; and
a housing within which is arranged:
a core arranged on a side of the housing opposite to the valve sleeve,
a coil wound onto a coil former, the coil former comprising a first portion with an internal diameter and a receiving bushing for the valve sleeve arranged on a side opposite to the core, the coil former and the receiving bushing being configured in one piece,
an armature configured to be movable and to act directly or indirectly on the at least one valve closure element, the armature being mounted in the coil former via a bearing and comprising a plurality of parts including a first part directed toward the core having a diameter, the diameter of the first part being larger than the internal diameter of the first portion of the coil former, and
a multiple-part return-path arrangement,
wherein the coil, the armature, the core and the multiple-part return-path arrangement together form an electromagnetic circuit.

12. The solenoid valve as recited in claim 11, wherein parts of the multiple-part return-path arrangement are arranged in the coil former.

13. The solenoid valve as recited in claim 11, wherein the coil former further comprises a second portion with a diameter opposite to the valve closure element, and wherein a portion of the core arranged opposite to the armature comprises a diameter which is larger than the diameter of the second portion of the coil former arranged opposite to the valve closure element.

14. The solenoid valve as recited in claim 11, further comprising a plug connection, wherein the valve plunger is adapted to be connected with the armature via the plug connection.

15. The solenoid valve as recited in claim 14, wherein the plug connection is configured to be adjustable.

16. The solenoid valve as recited in claim 11, further comprising a welding joint, wherein the receiving bush and the valve sleeve are connected by the welding joint.

17. The solenoid valve as recited in claim 11, wherein the first portion of the coil former comprises a bearing bush for the armature.

18. The solenoid valve as recited in claim 11, wherein the first portion of the coil former is configured as a bearing portion for the armature.

19. The solenoid valve as recited in claim 11, wherein the coil former is formed using an injection molding process.

20. The solenoid valve as recited in claim 11, wherein the coil former is formed from a dimensionally and temperature stable material.

21. The solenoid valve as recited in claim 20, wherein the dimensionally and temperature stable material is selected from Grivory® HT2V-3H LF or Grivory® XE3881.
